(19) United States
(12) Patent Application Publication
(10) Pub. No.: US 2022/0397775 A1
(43) Pub. Date: Dec. 15, 2022

(54) CONTACT LENS FOR EYE

(71) Applicant: Dopavision GmbH, Berlin (DE)

(72) Inventors: Hamed Bahmani, Berlin (DE); Yeshwanth Seshadri, Berlin (DE)

(21) Appl. No.: 17/777,282

(22) PCT Filed: Dec. 11, 2020
(86) PCT No.: PCT/EP2020/085836

§ 371 Date: May 17, 2022

(30) Foreign Application Priority Data
Dec. 13, 2019 (LU) LU101543

(51) Int. Cl. G02C 7/04; G02C 7/16

(52) U.S. Cl. CPC G02C 7/049; G02C 7/16; G02C 2202/20

(57) ABSTRACT

A contact lens (200) having an optical axis (240) and comprising an aperture (220) on the surface (210) is disclosed. The aperture (220) is located off-center of the optical axis (240) and the aperture (220) has a central axis which is arranged such that collimated light existing the aperture (220) is directed towards a blind spot (135) at the head of an optic nerve.

### CROSS RELATION TO OTHER APPLICATIONS

This application claims the benefit of and priority to Luxembourg Patent Application No. LU 101543, filed on 13 Dec. 2019. The entire disclosure of Luxembourg Patent Application No. LU 101543 is hereby incorporated by reference.

### FIELD OF THE INVENTION

The invention relates to an optical lens for an eye.

### BACKGROUND TO THE INVENTION

The retina in the human eye comprises, among other types of cells, photoreceptor cells which are divided into rods and cones and which absorb the light incoming to the human eye. The rods are primarily responsible for signaling in low-light conditions and the cones are responsible for color vision in bright light conditions.

The signals from these photoreceptor cells are sent to bipolar cells which are present in the inner nuclear layer of the eye and these signals are in turn sent to ganglion cells which are present in the ganglion cell layer. The ganglion cells deliver the information to the visual processing centers of the brain. The axons of ganglion cells are bundled together to form the optic nerve that connects to the retinohypothalamic tract (RHT) of the eye. It is known that the optic nerve connects to the RHT via an optic disc which is like a “pseudo hole” in the back of the retina in the eye. This optic disc forms effectively a blind spot at the head of the optic nerve in the retina due to the lack of the photoreceptor cells (i.e. rods and cones) located in the retina.

In addition to the two types of photoreceptor cells described above, it is known that there is further a further light sensitive photoreceptor called melanopsin which is also present in the retina. The melanopsin is a type of photopigment and is receptive to light (also called radiation) at a peak 480 nm wavelength. In humans the melanopsin is found to be expressed in certain ganglion cells which in turn make the melanopsin to be photosensitive and hence the melanopsin has been labelled historically “Intrinsically Photosensitive Retinal Ganglion Cells” (ipRGCs). The axons of ipRGCs express therefore melanopsin and like every other ganglion cell, the ipRGCs are also part of the optic nerve.

The blind spot of the human eye at which the optic nerve is present is therefore not really “blind” due to the fact that the axons of the ipRGCs are able to express the light-sensitive melanopsin. This is possible only because the optic nerve is myelinated (enclosed in myelin sheath) only after the lamina cribrosa layer but is left open at the optic nerve head.

It is therefore possible to stimulate the melanopsin by applying light/radiation with a wavelength of around 480 nm at the optic nerve head while leaving the other photoreceptor cells (rods and cones) untouched making the incoming light effectively ‘invisible’.

It is generally believed that the high energy blue light has a phototoxic effect on classical photoreceptors of the eye. Therefore, it is advantageous to stimulate the melanopsin with blue light on the optic nerve head where there are none of these classical photoreceptor cells (rods or cones).

The melanopsin is expressed in the axons of ipRGCs which are synaptically linked to dopaminergic amacrine cells (DAC) that release the neurotransmitter dopamine (DA). Thus, stimulating the blind spot in turn can provide a response from the DAC and hence regulate the dopamine level. Elevated DA levels are known to inhibit myopia progression, as is known from Feldkaemper et al “An updated view on the role of dopamine in myopia”, Experimental Eye Research, 114 (2013), 106-119. Thus, an “invisible” stimulation of the blind spot with the blue light can inhibit the myopia progression or prevent or delay the onset of myopia.

The melanopsin is also shown to modulate the pupil light reflex (PLR). Thus, stimulating the blind spot in turn modulates the PLR. In other words, a detected PLR in response to the stimulation of the blind spot with the blue light could be an indirect evidence for presence of the melanopsin on the optic nerve head.

Human observers can identify the content of a visual stimulus (e.g. orientation of grating stimulus) when the visual stimulus has high contrast. When the contrast is reduced to lower than a certain threshold level, the human observers cannot identify the stimulus feature (e.g. orientation) correctly. Such threshold is called “contrast sensitivity threshold”. It has been shown that the contrast sensitivity increases in the human observers with a higher level of the dopamine. Thus, contrast sensitivity function (CSF) can be an indirect measurement for retinal dopamine levels.

The melanopsin-encoding ipRGCs also carry the information to the suprachiasmatic nuclei (SCN). The SCN area cluster of cells in the hypothalamus receive the transduced light-dark time cue signals, indicating the transition from light to dark and distribute the light-dark time cue signals via endocrine and neural pathways to various systems of the body. Thus, stimulating the melanopsin at the blind spot is known to regulate the circadian rhythm.

Studies indicate that the stimulating of the melanopsin in the blind spot may be used in therapy for treatment of patients suffering from chronobiologic disorders such as myopia, circadian rhythm sleep disorders, sleep disorders, pupil dilation, delayed and advanced sleep phase syndromes, mood disorders, seasonal affective disorder such as depression or fatigue, postpartum depression, cancer risks, hormonal disorders, alertness disorders and cognitive performances, appetite and obesity, memory disorders, psychomotor disorders, body temperature deregulation, premenstrual disorders, epilepsy crisis.

The stimulation of the melanopsin can be also used to achieve increased levels of human alertness and performance e.g. in working environments and to treat various other disorders such as migraines, anxiety, Obsessive Compulsive Disorder (OCD), and alcohol and nicotine addiction.

A device and a method for treatment of the visual system of a human, including retina visual cortex and other neuro-cellular structures is taught in US Patent Publication No. 2007/0182928 (Sabel). The method of US '928 describes includes the step of defining and locating a blind zone of deteriorated vision within the human's visual system, defining a treatment area which is located predominantly within the blind zone and treating the human's visual system by presenting visual stimuli. The US'928 patent application does not disclose, however, the structure of a contact lens placed on the eyeball to aid treatment.

International patent application WO 2018/224671 illustrates a method and apparatus for the application of light onto the optic disk to stimulate the optic disk and describes a field of vision limiting device. The patent application, however, does not disclose the structure of the field of vision limiting device.

A contact lens having an implicit optical axis and comprising an aperture on the surface is known from U.S. Pat. No. 3,297,396 A. The aperture of US' 396 is located off-center of the optical axis and the aperture has a central axis which is arranged such that light entering the aperture is directed towards a blind spot. The aperture is provided to dissipate heat and to aird in tear circulation through the lens. There is no collimation of the light and US'396 does not teach, however, how such an arrangement can direct the light to the blind spot if the light is not collimated. The application does not teach how a simple aperture without a guiding tube can direct non-collimated light in a specific direction and thus prevent the entering light to the aperture from hitting other parts of the eye outside the blind spot. The application teaches a coating inside the aperture wall which reduces the scattering light but does not disclose more information about the desired size of the target projection of outside light on the blind-spot and specificity of anti-reflection coating towards the blue light which is known to cause more stray light in the eye. The application does not teach how to keep the contact lens in a position such that the aperture always directs the light towards the blind spot.

A further contact lens is known from U.S. Pat. No. 5,719,656 A. US' 656 describes a lens body of conventional soft contact lens composition, having a generally spherical concave back surface adapted to fit the cornea of the eye, and a generally convex front surface. The lens preferably includes a prism ballast to ensure correct orientation. The lens is made of opaque or other substances which generally do not transmit light. In the process, the eye is mapped with a conventional field test to determine the diseased portion of the eye and those portions of the eye having optical perception. Through the lens surface, circular channels or “pinholes” which traverse the entire thickness of the lens are placed in an area which maps and therefore corresponds to the portion of the retina having optical perception. Light incident on the underlying portion of the retina having optical perception through the pinholes provides improved vision. These pinholes can be made in the form of channels. Such channels further increase tear distribution under the lens with improved comfort to the wearer. The channels additionally provide increased oxygen flow to the cornea and lens, thereby diminishing the physiological burden occasioned by standard soft contact lens. US' 656 describes a contact lens with several pinholes, which is supposed to increase the visual acuity at the visually sensitive areas of the retina. US '656 does not teach an arrangement to direct the light to optic nerve head which is the opposite area in the retina to fovea in terms of visual sensitivity and photoreceptor density. Moreover, the aperture does not provide the optical guide tube to collimate the light and direct the light to the small area of the optic nerve head.

A further contact lens is known from UK Patent Application No. GB 2 458 495 A. GB' 495 describes a soft contact lens with a cosmetic-colored area and an opaque iris with a plurality of pinholes arranged so as to direct light to a light sensitive part of the retina of a wearer. The wearer's ophthalmic prescription may be incorporated into the contact lens. GB' 495 describes a trial contact lens designed to determine the optimal pinhole arrangement for a wearer, e.g. by axis markings. The contact lens of GB' 495 may be truncated or back weighted to stabilize its position in the wearer's eye. Prisms such as yoke prisms may be included to alter the direction of the light transmitted by the pinholes into the eye. The contact lens pinhole positioning of GB' 495 may be based on the results of digital retinal mapping. The contact lens wearer may further add magnification by the use of LVA (low vision aid) telescopic systems. The device of GB' 495 may remedy retinal damage related sight loss e.g. age-related macular degeneration (AMD). Prism lenses of GB' 495 may also be used to decenter a single central pinhole image transmitted by a single pinhole contact lens. GB' 495 discloses therefore a contact lens with multiple pinholes in order to direct light to light sensitive areas of the retina of a wearer. Parameters of the lens of GB' 495 are optimized for the best vision of the wearer. The plurality of pinholes of GB' 495 are supposed to direct the light to the predetermined area on the retina to obtain best vision, which is different from directing light to the non-light sensitive blind spot in the retina.

U.S. Patent Application No. US 2019/302481 A1 describes a spectacle with regions of Frensel lens such that the overall thickness of the lens can be made thinner. US' 481 describes a resbyopia treatment and anti-myopia spectacles comprising a negative refractive element facing an object and a positive refractive element facing a patient eye. The negative refractive element of US' 481 has a central zone with a strong negative refractive power. The positive refractive element of US' 481 has a central zone with a less strong positive refractive power. The front focal point of the central zone of the positive lens of US' 481 does not have to overlap with the front focal point of the central zone of the negative lens. The negative refractive element and the positive refractive element of US' 481 are axially separated by a relatively small distance such that the combination of the two refractive elements is compact enough to be made into an easily wearable spectacle. For myopia progression control, at least one portion of the paracentral and/or peripheral zone of at least one of the two refractive elements of US' 481 has a relative add power with respect to that of the central zone such that the image of an off-axis distant or intermediate object is formed in front of a corresponding paracentral or peripheral retina area to create myopic defocus on the corresponding retina area.

### SUMMARY OF THE INVENTION

The contact lens of this document has an optical axis and comprises an aperture on the surface of the contact lens. The aperture is located off-center of the optical axis and the aperture has a central axis which is arranged such that collimated light exiting the aperture is directed towards a blind spot. This enables treatment light to be focused on the blind spot to enable generation of dopamine without affecting the vision of the participant wearing the contact lens.

In one aspect of the contact lens there is a tube connected to the opening of the aperture which protrudes from the surface of the contact lens. This enables better focusing of the light onto the blind spot and in another aspect the tube is formed as an aperture through the contact lens.

The tube is coated on its inner surface with a non-reflective coating. This prevents the light, for example in a wavelength of 420 nm to 500 nm (blue light), from reflecting inside the tube and scattering back to the regions of the retina outside the blind spot.

In a further aspect of the contact lens the contact lens is made of a material filtering out light of a specified radiation or a spectrum of wavelengths. This is used to avoid flooding the eye with the light in the visual treatment spectrum. The light in the visual treatment spectrum can still enter the eye through the aperture and/or the tube.

The contact lens could comprise a plurality of Fresnel lenses for also focusing the light on the blind spot.

The contact lens could comprise a prism ballast to stabilize the contact lens against rotation and maintain the aperture at the right coordination with the blind spot.

A system for applying radiation to a blind spot in an eye is also taught in this document. The system comprises a light source for emitting the radiation and the contact lens as described in this document. The light source is a light-emitting diode.

In one aspect of the system, the light source is placed at a front entry of one of the tube or the aperture.

### DESCRIPTION OF THE FIGURES

FIGS. 1A and 1B show examples of the experimental setup.

FIG. 2 shows a first embodiment of the contact lens.

FIG. 3 shows the simulation of the contact lens.

FIG. 4 shows a second embodiment of the contact lens.

FIG. 5 shows a third embodiment of the contact lens.

FIGS. 6-8 shows a pupil light response.

FIG. 9 shows a contrast sensitivity function.

FIG. 10 shows collimated light entering the eye.

FIG. 11 shows a contact lens with a plurality of Fresnel lenses.

FIGS. 12 to 15 show a contact lens of a fourth embodiment of the contact lens.

### DETAILED DESCRIPTION OF THE INVENTION

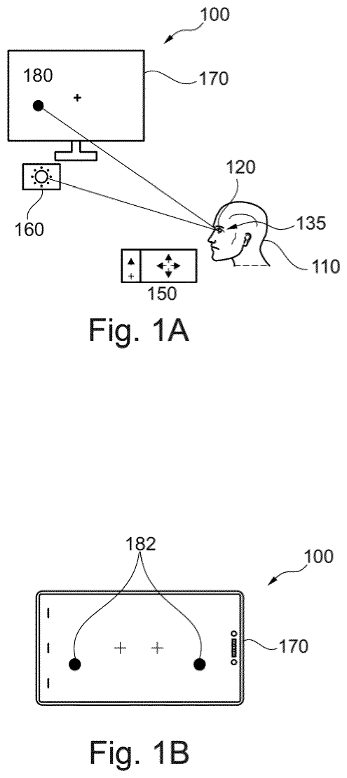

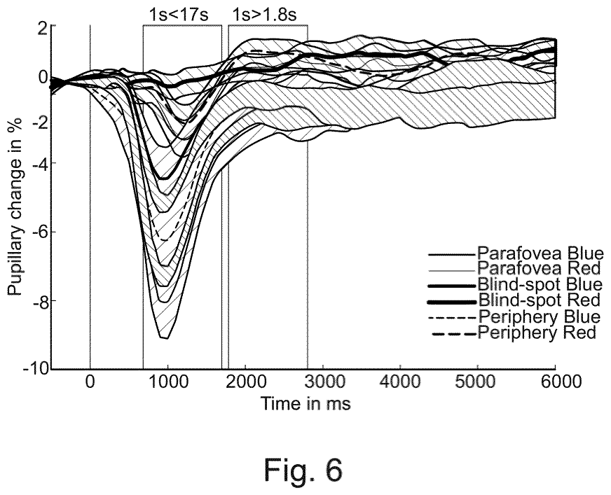

An example of an experimental apparatus 100 used in this document is illustrated in FIG. 1A and shows the experimental apparatus where a blind spot 135 of a human observer (participant) 110 is stimulated with a blue color visual stimulus 180 on a computer screen 170. The visual stimulus 180 comprises in this non-limiting example a circular disc with blue color and a size which fits to the blind spot 135 of the participant 110 in the experiments. A calibration phase of the experimental program allows precise adjustment of size and location of the visual stimulus 180 to the blind spot 135 by pressing arrows on a keyboard 150, until the participants 110 report the visual stimulus 180 as being invisible. Although the light is received by the eyeball 120, this is the position at which the participants 110 report no conscious perception of the visual stimulus 180 in their visual field. An eye tracking device 160 monitors the pupil responses in the eyeball 120 of the participants 110. After flashing the visual stimulus 180 to the blind spot 135 of the participants 110 for 80 ms, there is a pupil response (PLR) captured by the eye tracking device 160 which is depicted in FIG. 6. Such PLR does not exist in response to red stimulus; therefore, the observed PLR is attributed to the melanopsin with peak sensitivity to blue light at the optic nerve head around the blind spot 135.

FIG. 1B shows an example of the apparatus 100 used as a blind spot stimulation device to measure changes in the contrast sensitivity function (CSF) of the participants 110 before and after stimulating the blind spot 135 with blue light. The participants 110 respond using the keyboard 150 to a standard contrast sensitivity test program, for example, the Freiburg Acuity and Contrast Test (FrACT) or the Tubingen Contrast Sensitivity Test (TueCST) while looking at the screen 170 of the apparatus 100 in FIG. 1A, before and after stimulation of the blind spot 135 with apparatus 100 in FIG. 1B.

The CSF test comprises a display of multiple Gabor patches presented as the visual stimulus 180 to the human participant 110 on the display device 170 at different orientations, spatial frequencies and contrasts. The spatial frequency of the Gabor patches is defined by the number of parallel strips in the Gabor patches in a given special distance and is measured in cycles per degree (cpd). A computer programmed algorithm changes the contrast and the spatial frequency in a logical manner and the orientation of the Gabor patches in a pseudo-random manner. The participant 110 reports the orientation of the Gabor patch on the display device 170 by pressing arrows on the keyboard 150.

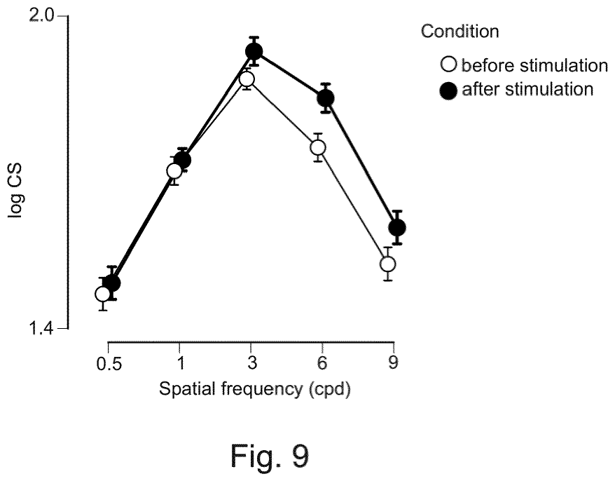

The device in FIG. 1B is a smartphone with the display device 170 being the screen of the smartphone. The smartphone generates a blue light 182 for one minute to stimulate the blind spot 135 with blue light for 1 minute. The CSF is computed before the stimulation of the blind spot 135 and again 20 minutes after stimulation of the blind spot 135 by the blue light 182 of the apparatus 100 of FIG. 1B for 1 minute. Both of the CSFs are computed with the same test and are depicted in FIG. 9.

The contrast sensitivity (CS) shown on FIG. 9 is the reciprocal of the minimum contrast required for detection and reporting of the orientations of the Gabor patches by the participant 110, and this contrast is called the “threshold contrast”. The contrast sensitivity plotted against the spatial frequency of the Gabor Patch reveals the contrast sensitivity function (CSF) of the eye. The y-axis in FIG. 9 is the CS in log scale. The CSF improvement in higher spatial frequencies is believed to be due to increased dopamine (DA) levels after stimulation of the blind spot 135 with the blue light 182. This improvement is not present in the lower spatial frequencies which rules out the adaptation or learning effect in the performance of participants 110.

This experimental data provided above suggest that stimulation of the blind spot 135 with blue light leads to modulated levels of retinal DA. This document teaches a method of invisibly stimulating the blind spot 135 with light while the participant 110 is not aware of presence of the light on the stimulation site, because there is no classical photoreceptor cell on the blind spot 135 which contributes to the image-forming visual system. However, the melanopsin exists on the blind spot 135 and leads to pupil constriction as well as increased levels of the dopamine, presumably via DAC neurons in the retina.

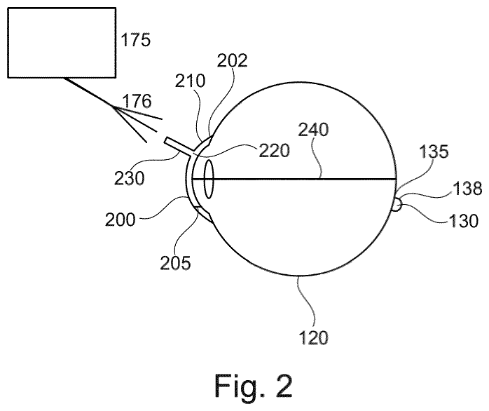

FIG. 2 shows a diagram of the eyeball 120 of the participant 110 wearing a contact lens 200 as would be seen in practice. The contact lens 200 of this document guides the radiation 176 from a light source 175 in such a way similar to the placement of visual stimulus 180 on the blind spot 135 by the computer program in the experimental setup 100 shown in FIGS. 1A and 1B that the light for stimulation reaches the blind spot 135 and not the rest of the retina. The light for stimulation in practice is not from a computer screen on the display device 170, but is a separate light source 175.

Three different types of contact lenses 200 will now be described. The contact lenses 200 enable isolated stimulation of the blind spot 135 which is intended to activate the melanopsin. The contact lenses 200 also work during movements of heads and eyes by a patient wearing the contact lens 200. The contact lens 200 can be made of soft contact lens materials that are low or high in water content which can be either ionic or non-ionic. The contact lenses 200 will be generally opaque and see-through but will not allow light from the light source 170 to reach the retina, but to allow the light to reach the blind spot 135. Examples of the materials include, but are not limited to, rigid materials (PMMA or RGP) or hybrid materials. In the case of opaque contact lenses 200, other materials (plastics, polymers) can be considered.

The system and the contact lens 200 can be made of a light permeable material with a notch filter. This notch filter enables ambient light to reach the whole of the retina but does not allow the passage of light/radiation 176 in the treatment light spectrum (e.g. blue light about 480 nm). The notch filter is a very narrow bandwidth band-stop filter. The treatment light spectrum (e.g. blue light) existing in the ambient light as a natural part of the ambient light can, however, pass through the pinhole (i.e. through the aperture 220) and exclusively stimulate the blind spot 135.

The system and the contact lens 200 can also be made of light-polarizing material or coating which allows the radiation 176 from the light source 175 to pass through the contact lens 200 at a certain angle but not at other angles.

Targeted stimulation of the blind spot 135 through the aperture 220 can be considered as being logically equivalent to an optical wave guide. An isolated targeted stimulation of the blind spot 135 can be achieved by different variations of optical design, as will now be described in the following examples.

The system and the contact lens 200 have numerous applications. In a first application the contact lens 200 is worn by children in a classroom for the treatment duration and the treatment light 176 is emitted from a fixed light source 175 in the classroom. One use of such a setting is to prevent or delay the onset or slow down the progression of myopia in the school children. The contact lens 200 used in this use is transparent and allows the school children to see their visual environment with full details, but eliminates the passage of the treatment light spectrum through the contact lens 200 because this spectrum might otherwise cause harm to con-photoreceptors and rod-photoreceptors in the eye which exist outside the blind spot 135. The treatment light spectrum (e.g. 480 nm) passes through the aperture 220 and reaches the blind spot 135 in a safe and invisible manner to trigger more dopamine release for size regulation of the eyeball 120 and thus preventing or delaying the onset or slowing down the progression of myopia.

In a further application, the contact lens 200 is worn by people in an office for the treatment duration and the treatment light is emitted from a fixed light source 175 in the office.

The contact lens 200 can be worn by a patient group (e.g., children) while the patient group plays a video game or watches a movie or when working. The light source 175 with the treatment light spectrum is integrated in the screen of the video game or movie player.

In one application, the contact lens 200 is worn by the patient group or healthy people during flight with the treatment light spectrum either coming from the light source 175 in the aircraft or from the contact lens 200 itself (like in Example 2 described below). This can enable the passengers' circadian rhythm to tune to the destination time and thus reduce jet lag. In this application, the contact lens material can be light blocking (black material) which allows the passage of no light to the retina. The only portion of the light reaching the blind spot 135 can pass through the aperture 220. The contact lens 200 in this application can serve as a sleeping mask for sleeping while the necessary blue light for circadian clock adjustment reaches the blind spot 135 invisibly.

In one application, the contact lens 200 is used by a shift worker. This can be used to reduce fatigue from which the shift worker suffers due to sleep deprivation or off-phase cycle of natural sleep.

In another application, the contact lens 200 can be worn by anybody in everyday life outdoors with bright sunlight to reduce risks of bright light for retina. The contact lens 200 eliminates the high intensity blue spectrum of sunlight reaching the retina but allows the full spectrum of bright light reaching the blind spot 135 which is important for circadian rhythm regulation and normal growth of the eyeball 120.

In another application, the contact lens 200 can be used as an interocular lens (IOL).

In one application, the contact lens 200 is used to achieve pupil constriction in experimental setup or otherwise. It will be appreciated that the contact lens 200 can also be used to illuminate the blind spot 135 exclusively for other experimental procedures, such as photocoagulation of the optic nerve head 138.

In one application, the contact lens 200 is used to stimulate the blood vessels in the optic nerve 130 by the light source 170.

In one application, the contact lens 200 is used in eye examinations for diagnostics purpose.

In one application, a room can be installed which is lit with by the light source 175 emitting light/radiation 176 in the treatment light spectrum. The patient group can visit the room to obtain the treatment and will be provided with contact lenses 200 to wear.

In one further aspect, the contact lens 200 comprises a prism ballast to stabilize the contact lens against rotation and maintain the aperture at the right coordination with the blind spot. Prism is widely used in toric soft contact lenses among several other methods and is one of the most common stabilizing techniques. A prism of between 1.00 to 1.50 D is ground base down into the lens. However, greater amounts of prism may be needed for patients with particularly tight lids, flat corneas, or oblique axis astigmatism.

### Example 1

FIG. 2 shows an example of the contact lens 200 with an aperture 220 on the surface 210 of the contact lens 200. The dimension of the aperture 220 depends on various factors. The aperture 220 is located off-center to the optical axis 240 of the contact lens 200. The exact position of the off-center depends on the location of the blind spot 135 on the retina relative to the optical axis 240. From the aperture 220, a tube 230 is protruded from the surface 210 of the anterior lens surface 202. The tube 230 is angled at a degree (for example 5 to 20 degrees) relative to the surface normal. The angle is positive if the tube 230 is arranged on top of the optical axis 240 and negative if the tube 230 is arranged at the bottom of the optical axis 240. The diameter of the tube 230 is substantially the same as the diameter of the aperture 220. The length of the tube 230 depends on the central thickness 205 of the contact lens. The thicker the central thickness 205, the smaller the length of the tube 230 and vice versa. The length of the tube 230 can take range of exemplary values from 0 mm to 10 mm, but this is not limiting of the invention. To prevent scattering of visible light inside the tube, the inside of the tube 230 is coated using an optical coating which is an anti-reflective to light in the wavelength range between 420 nm and 500 nm.

The thickness and material of the anti-reflection coating depends on the refractive index of the contact lens 200 and the range of wavelength to be controlled. In most cases, for 480 nm light and broadly for visible light, it is possible to use a coating thickness of between 50 nm to 500 nm. The common materials used are MgF₂ (1.39), SiO2 (1.48) and Al₂O₃ (1.60) and black carbon. Other possible materials (along with their refractive indices in brackets) used are cryolite (1.35), LiF (1.37), ThF₄ (1.52), CeF₃ (1.62), PbF₂ (1.73), ZnS (2.30), ZnSe (2.55), Si (3.5), Ge (4.20), Te (4.80), PbTe (5.50), MgO (1.72), Y₂O₃ (1.82), Sc203 (1.86), SiO (1.95), HfO₂ (1.98), ZrO₂ (2.10), CeO₂ (2.20), Nb₂O₅ (2.20), Ta₂O₅ (2.10), and TiO₂ (2.45) and polyelectrolyte multilayers.

To increase the wavelength covered that is blocked from reflection, it is possible to add more coating layers to the anti-reflection coating. The materials used in the layers and the thickness of the layers take the values mentioned above. It is also possible to use lithographic etching on the surface of the contact lens 200 to provide an approximate anti-reflection coating. This setup enables that, when the contact lens 200 is fitted about the eyeball 120, the light entering the eye is focused on the optic nerve head 138 of the optic nerve 130 in the eye, with some scattering possible around the optic nerve head 138.

The setup ensures that the light falls in the optic nerve head 138 even when accounted for eye movements since the contact lens 200 moves along with the eye.

The setup means that the radiation 176 in the treatment light spectrum can be from any type of light source 175 and does not need to be collimated light. All directions of light hitting the surface of the lens 200 will not enter the aperture 220 and the non-reflecting coating on the tube 230 stops all light rays except the parallel rays to the axis of the tube 230 which ensures the stimulation of blind spot 135 with this bundle of light rays.

In all the variants, the contact lens 200 can also be made in such a way to also correct the vision of the user, as is common with the contact lens 200.

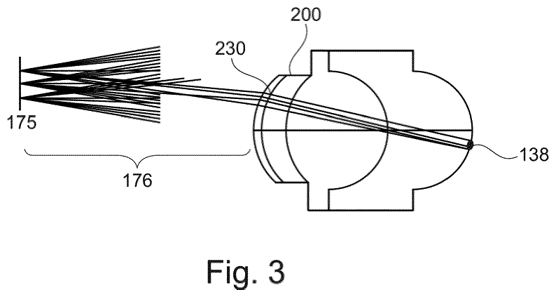

An optic simulation of the light 176 from the light source 175 and the contact lens 200 can be carried out by using the optical simulation software such as ZEMAX-EE optical design program. The entry of light 176 from the light source 175 into the contact lens 200 is shown in FIG. 3. The light source 175 emits the radiation 176 at multiple angles which enters the tube 230 which is, as noted above, coated with non-reflective interior surface. The tube 230 is represented in the software simulation by a series of apertures for ease of calculations and representation in drawing. Most of the radiation 176 entering the tube 230 is as a result blocked and only the light directed directly at the optic nerve head 138 is let through. No image is formed at any of the photoreceptor cells at the optic nerve head 138 and thus the patient 110 wearing the contact lens 200 would not perceive the light 176 coming from the light source 175.

### Example 2

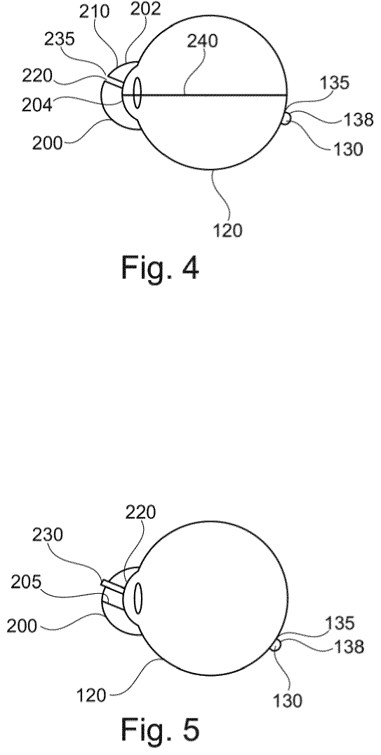

The contact lens 200 shown in FIG. 4 is similar to that of FIG. 2 except that the tube 230 is replaced by a deep aperture 220. The contact lens 200 is designed with sufficient thickness, for example 0.2 to 10 mm, but this is not limiting of the invention. An example is known in a guinea pig animal model a lens with 3.5 mm central thickness has been used in “Jnawali, Ashutosh, Krista M. Beach, and Lisa A. Ostrin. “In vivo imaging of the retina, choroid, and optic nerve head in guinea pigs.” Current eye research 43.8 (2018): 1006-1018″. The contact lens 200 is endowed with a hole forming the aperture 220 whose dimension depends on various factors. In a similar manner to that in the first example described above, the aperture 220 is located off-center to the optical axis 240 of the contact lens 200. The hole forming the aperture 220 is angled from the anterior lens surface 202 to the posterior lens surface 204. This hole in combination with the lens thickness acts as a ‘pseudo’ tube. The interior of the hole/pseudo-tube is coated with a non-reflective coating (such as those disclosed above) for the visible wavelength. This setup ensures that, when the lens is fitted, the light is only focused on the optic nerve head 138 with some possible scattering around. The variation being that there is no protrusion from the contact lens 200 and thus can be used as an interocular lens (IOL).

### Example 3

The third example of the contact lens 200 is a combination of the first and second embodiments with a compromise between the lens thickness and the tube length 230. This third embodiment is shown in FIG. 5.

The materials from which the contact lens 200 and the properties of the light 176 from the light source 170 will be described in more detail below.

### Example 4

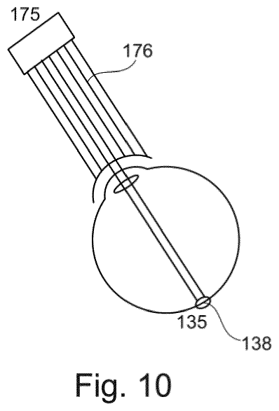

In example 4, the contact lens 200 does not have a protrusion 230 or enough thickness to form a pseudo-tube by the hole itself. Therefore, the treatment light 176 needs to hit the contact lens 200 perpendicularly at the aperture 220 and the light rays of the treatment light 176 need to be collimated in order to reach the blind spot 135 at the optical nerve head 138 exclusively. In such example, the light source 170 needs to be a collimated light source, as shown in FIG. 10.

### Example 5

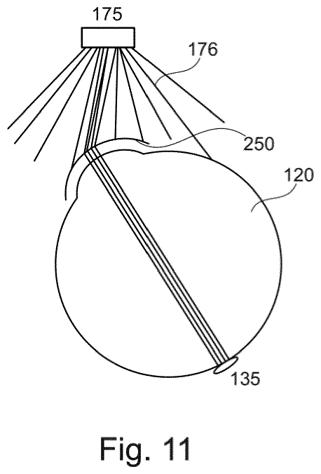

In another example, the aperture 220 is not a pinhole but instead the aperture 220 comprises a group of micro-lenses which direct the light rays 175 of different directions from any light source 170 to the target blind spot 135 in a bundle of parallel light rays. One form of such group of micro-lenses is a Fresnel lens 250, as shown in FIG. 11.

### Example 6

In another example, the whole contact lens 200 is composed of micro lenses like Fresnel lens 250 and directs the light 176 of every direction to focus on the blind spot 135. This example does not allow the light 176 to reach the other parts of the retina, therefore is not suitable for simultaneous treatment of blind spot 135 with blue light and normal vision. An application of such example of contact lens 200 can be for jet lag (like a sleep mask) because the patient 110 does not need to see the visual environment and the light only converges on the blind spot 135.

### Embodiment 1

In all three examples of the contact lens 200, the light source 170 is located outside of the contact lens 200, as can be seen in FIG. 1. The light source 170 can be any kind of light emitting device. The light source 170 is fixed with respect to the eye 120 i.e., the light source 170 can be a fixed at the corner of a room/location. The contact lens 200 is opaque so as to not let the treatment light 176 enter the eye 120 through to the retina and thus ensuring that the treatment light 176 only reaches the blind spot 135.

The arrangement of the light source 170 and the contact lens 200 described in embodiment 1 enables centralized treatment to a group of subjects. The light can be installed in classroom for children to slow down the progression of myopia, can be installed in airplanes to remove jetlag and can be installed in offices, factories, and homes.

### Embodiment 2

A small form factor light source, like but not limited to a pico-LED, is used as the light source 175 and is placed at a front entry (anterior part) of the tube 230 (or the aperture 220 in example 2) so that the rays of the light 180 travel only to the blind spot 138. The light source 175 is hence an integrated part of the contact lens 200. The non-reflective coating ensures that the light 176 still only stimulate the blind spot 135. This allows the contact lens 200 to be transparent instead of being opaque so that the user can see the real world.

There is also option to replace pico-LED as the light source 175 with an optical fiber cable that is fixed in the same way as the pico-LED.

In one alternative aspect, the pico-LED can be replaced as the light source 175 with an additional lens which has integrated light source in itself. Such an additional lens can be powered by radiofrequency power source or connect to external power source with a micro-cable. The light source 175 integrated into the material of the additional lens must be centered at the front entry 235 of aperture 220 of the contact lens 200 in the Example 2 shown in FIG. 4. A precise fitting of the additional lens to the contact lens 200 enables the passage of light from integrated light source 175 of the additional lens to the blind spot 135 through the aperture 220.

### Embodiment 3

In this aspect, the treatment light 176 from the light source 175 is directed to the eyeball 120 and is polarized. This polarized treatment light 176 can illuminate a room or an area so that many users can share the treatment. The contact lens 200 is coated in such a way to block this polarized treatment light 176 but to allow every other light from outside. Hence the polarized treatment light 176 enters through the front entry to the tube 230 in examples 1 and 3 and the entrance to the aperture 220 in example 2. This means that the treatment light 176 only reaches the blind spot 138 and not the retina. This allows the contact 200 lens to be transparent instead of being opaque where the user can see the real world.

### Embodiment 4

In this embodiment, the polarized treatment light 176 comes from any kind of wearable device, a smartphone or another portable light source 175. This allows for portability of the light source 175 for the treatment. The contact lens 200 design from embodiment 3 can be used.

### Embodiment 5

Different levels of filters for blocking the treatment light 176 can be used in the contact lens 200. This allows for many levels of ‘dim’ contact lens according to usage preference.

### Embodiment 6

It is possible to use different tints in the contact lens 200 which act as filters for different parts of the spectrum of the incoming light 176. The different tints (or colors) of the contact lenses 200 enable modulation of non-treatment light.

### Embodiment 7

Sunlight can act as the treatment light 176 and filters, as in embodiments 5 or 6, can be applied. This supports wearing this contact lens 200 also as a sunglass but still getting enough treatment light 176 at the blind spot 138.

### Embodiment 8

In another embodiment, the contact lens 200 covers a larger area of the eye (including iris and sclera) for more stability and the treatment light 176 with the blue spectrum reaches the iris and sclera of the eye, as it has been shown that the iris and sclera can absorb blue light and stimulate melanopsin.

### Embodiment 9

In another embodiment, the contact lens 200 can be worn in conjunction with a smart glass which has an inbuilt light source 175. A smart glass in this embodiment can be in the form of (but not limiting to) spectacle frame or eye glass frame such or head-mounted devices, head-up displays (for example in cars) or ambient or decorative light sources.

### Embodiment 10

In another embodiment, the contact lens 200 can be used with any screen for entertainment or educational purposes such as but not limited to virtual reality devices, TVs, beamer, game consoles, and personal computers.

### Embodiment 11

In another embodiment, the contact lens 200 can be worn together with seasonal affective disorder (SAD) lamps as the light source 175. These SAD lamps are high power bright lights and are uncomfortable and can be not safe for the eye.

### Experimental Data

FIG. 6 illustrates experimental data to support the proposition that blue light visual stimulus 180 on the optic nerve head 138 enhances pupillary light reflex (PLR). As noted in the introduction, there is no classical photoreceptor cell in the optical nerve head 138 and thus changes in the PLR are likely due to melanopsin activation. The stimulus used red or blue circular discs presented in three different locations of the retina: in the parafovea, in the peripheral retina and in the blind spot 135. The blue stimulus was composed of short-wavelength blue light with peak at 450 nm whereas the red stimulus was composed of long-wavelength red light with peak at 610 nm stimulus. Fifteen participants 110 were used as subjects and the participants 110 adjusted a circular stimulus 180 within the size and position of the blind spot 135 until the light stimulus 180 was invisible. While the right eye was covered, the left eye's pupil-response was recorded with an eye-tracker 160 (EyeLink1000) and blinks were removed. Post Illumination Pupil Response (PIPR) amplitude was analyzed for standardized time windows (1 s<1.7 s, 1 s>1.8 s and 2 s-6 s).

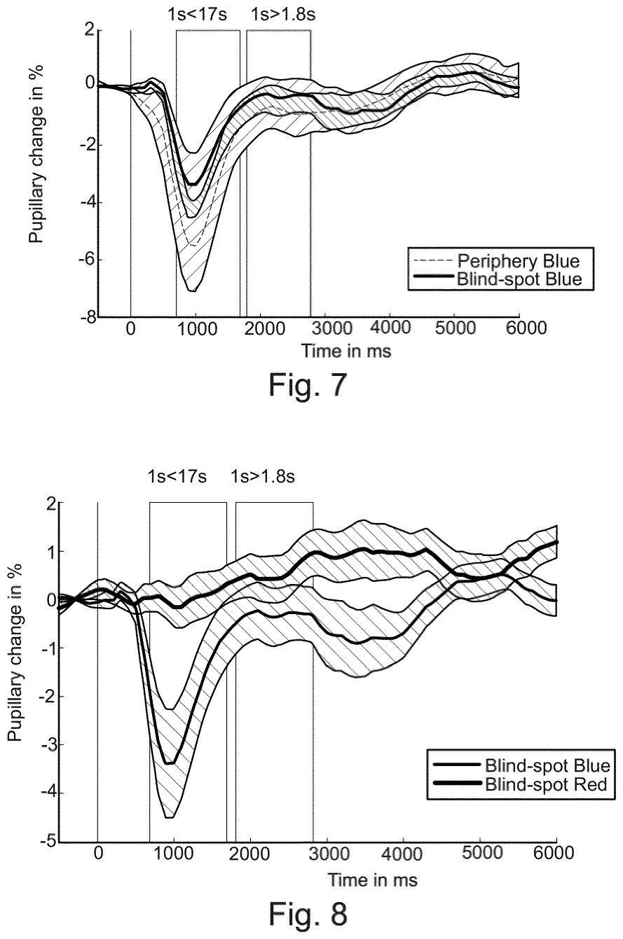

In all time windows, the blue stimulus showed a significantly stronger PIPR than the red stimulus (p<0.01). At times <1.7 s, the PIPR to parafovea was stronger than in the blind spot 135 (p<0.05). We observed an overshoot in parafovea and periphery red condition, but not at the blind spot 135. Therefore, we tested in blue conditions the hypothesis that there is no difference to blind spot 135 and this is shown in FIG. 7. At times >1.8 s, the blind spot 135 and the periphery PIPR is comparable with evidence for no difference.

At times 2 s-6 s, the blind-spot condition showed a significant larger pupillary change to blue compared to red light as is shown in FIG. 8.

In conclusion, the stimulation from the blue light visual stimulus 180 inside the blind spot 135 and outside the blind spot 135 in peripheral retina revealed a comparable melanopsin-mediated PIPR, although there are no rods and cones in the optic disc. In absence of the classical photoreceptor cells, the melanopsin seems to be responsible for the pupil constriction in the blind spot 135. This supports the presence of melanopsin on the axons of ipRGCs at the optic nerve head 138, which can constitute potential applications of stimulating melanopsin with visible light, although invisible to the observer.

Melanopsin cells provide input to the retinal dopaminergic system which modulates dopamine (DA). If the activation of melanopsin on the optical nerve head 138 could lead to increased levels of DA, it could provide a potential treatment for myopia via DA-regulated control of axial growth of the eyeball 120. Altered DA levels by dopaminergic drugs have been shown to improve contrast sensitivity (CS) in higher spatial frequencies (SF). We tested the hypothesis that stimulating the optic nerve head 138 with blue light increases the CS in such SFs.

The participants 110 were provided with a head mounted device, and first adjusted the size and position of a bright disk on the screen of the display device 170 to fit the blue light stimulus 182 inside the blind spot 135. Changes in the contrast sensitivity function (CSF) of the participants 110 before and 20 minutes after stimulating the blind spot 135 with blue light 182 for one minute on the display device 170 was measured by a standard contrast sensitivity test program while looking at the computer screen on the display device 170. The CSF test comprises multiple Gabor patches presented as the visual stimulus 180 to the human participants 110 on the display device 170 at different orientations, spatial frequencies and contrasts. The spatial frequency of the Gabor patches is defined by the number of parallel strips in the Gabor patches in a given special distance and is measured in cycles per degree (cpd). A computer programmed algorithm changes the contrast and the spatial frequency in a logical manner and the orientation of the Gabor patches in a pseudo-random manner. The participant 110 reports the orientation of the Gabor patch on the display device 170 by pressing arrows on the keyboard 150.

As noted above, the contrast sensitivity (CS) is the reciprocal of the minimum contrast required for detection, and this contrast is called threshold contrast. Contrast sensitivity plotted against the spatial frequency of the Gabor Patch reveals the contrast sensitivity function (CSF) of the eye. The contrast sensitivity values (CS) for spatial frequencies (SFs) equal to 0.5, 1, 3, 6 and 9 cycles per degree (cpd) were measured before and 20 min after simulation of the blind spot 135 with pulses of blue light flickering at 15 Hz for 1 min binocularly in ten participants 110. The results are shown in FIG. 9. Paired T-tests revealed a significant increase of CS for SFs higher than 2 cpd (p<0.05) after blind spot stimulation but no significant changes in CS for SFs lower than 2 cpd.

We concluded that stimulating the optical nerve head 138 with the blue light leads to CS improvement at higher SFs, which suggests a melanopsin-triggered modulation of retinal DA. Based on these results, a treatment strategy for myopia control by effectively modulating retinal DA by visible light—but invisible for the observer—is developed. It was observed that there is an application to significantly increase the retinal dopamine levels by stimulating the blind spot 135 with wavelength around 480 nm that is invisible to the participant 110 and safe to the retina since the phototoxic spectrum of the incoming light 176 does not target the rods and the cones.

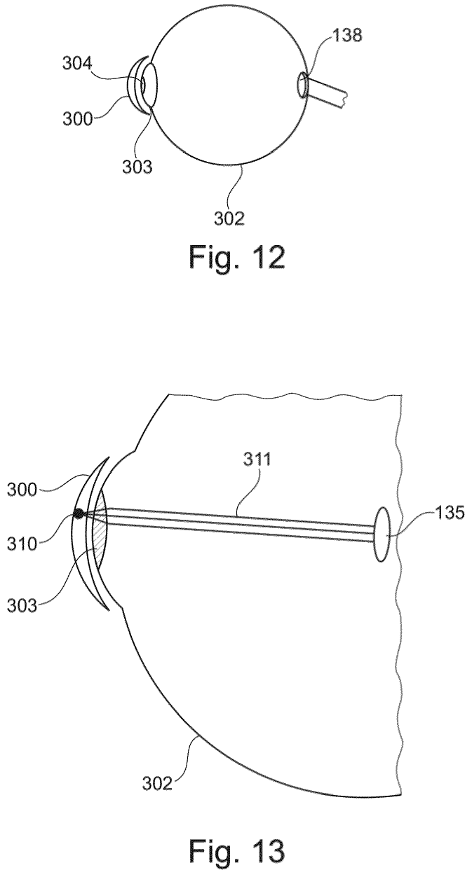

FIGS. 12 to 15 show a contact lens 300 of a further embodiment of the present invention for providing a smart contact lens 300 to be used for optic nerve light stimulation. The contact lens 300 of this embodiment comprises the same configuration as the contact lenses of the first, second and third embodiment except that the contact lens 300 is provided with an integrated light source 310. Thus, elements having substantially the same function as those in the first, second, and third embodiments of the present invention will be numbered the same here and will not be described and/or illustrated again in detail here for the sake of brevity.

The contact lens 300 is manufactured, for example, by volumetric 3D printing. The contact lens 300 can comprise a pico-LED as the integrated light source 310 in the contact lens 300, in order to stimulate the optic nerve head 138 of the wearer with a desired composition of light. However, the contact lens 300 is not limited thereto and other integrated light sources 310 can be used. As can be seen in FIG. 12, the contact lens 300 is placed over the pupil 304 and cornea 303 of a human eye 302.

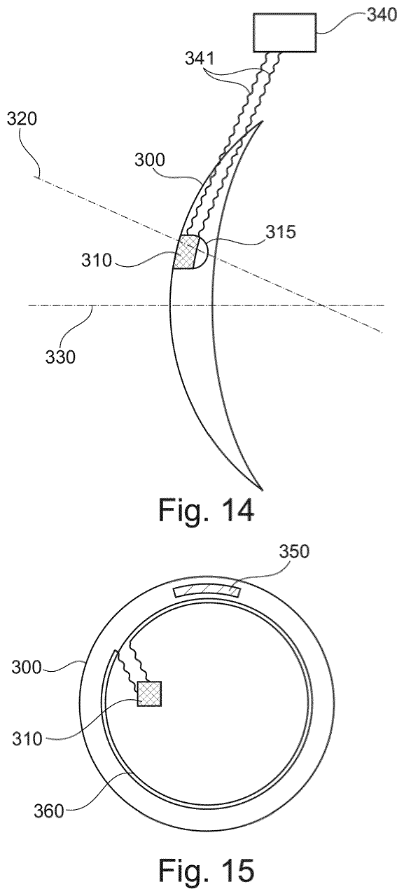

As can be seen in FIGS. 13 and 14, the contact lens 300 has an integrated pico-LED 310 as the integrated light source 310 placed off-axis 320 with respect to the central axis 330 at a location on the visual field corresponding to the optic nerve head 138 of the human eye 302 (i.e. blind-spot). The contact lens 300 may have additional optics, e.g. micro lenses 315, to focus the light on the head of the optic nerve head 138 and nowhere else on the retina, thus making the light stimulus invisible to the wearer.

The light of the integrated light source 310 is to be of short wavelength blue spectrum to maximally stimulate the melanopsin cells on their fibers, converging at the head of the optic nerve 138. In particular, light of 480 nm is used which is to provide the peak sensitivity for melanopsin cells.

Temporal composition of the light is controlled by a computer (not shown) which connects to the integrated light source 310 of the contact lens 300 with a variety of connectivity options. In one aspect, the duration of light stimulation by the integrated light source 310 is in the order of a few minutes for several times a day; therefore, energy consumption of the light source is limited and suppliable by a battery 340, 350, as can be seen in FIGS. 14 and 15. As shown in FIG. 14, the power of the integrated light source 310 can be provided by an external battery 340 via micro wires 341 or electromagnetic induction. As can be seen in FIG. 15, an integrated coil 360 planted inside the contact lens 300 can receive an electromagnetic current which is induced by a power source (not shown) on a spectacle frame to be worn together with the contact lens. Irradiance range (received at the optic nerve surface) by the light source is 50 to 350 microwatt/cm². As can be seen in FIG. 15, the contact lens 300 can also have an integrated battery 350. However, the contact lens 300 is not limited thereto.

As can be seen in FIG. 13, the beam diameter range 311 at the optic nerve is from 0.6 mm to 2 mm and should cover the blind spot, but not exceed the invisible area of the wearer blind spot. The beam is directed 4.5 mm (15 deg visual angle) nasal and 0.65 mm (2 deg visual angle) superior from the fovea center.

The contact lens 300 is supposed to be worn by 6-14 years or adults and therefore the curvature of the cornea 303 needs to be taken into account. The contact lens 300 can be worn together with a technology that lets the light pass through a tunnel in a contact lens and gets collimated before entering the eye vitreous chamber.

The contact lens 300 can be worn only during treatment times or the whole day, depending on the convenience of the wearing and biocompatibility. The contact lens 300 can be of any material, soft or hard (PMMA) as nowadays available in commercial contact lenses. The contact lens 300 can be washable (multi-use) or disposable (single-use). The contact lens 300 can be transparent for daily use, or designed to be for short-term use and from either transparent or black/tinted material to prevent the full-spectrum light from reaching the full retinal.

The contact lens 300 can be a plano lens or a lens with corrective power. Since the contact lens 300 is supposed to be used to control myopia progression, a corrective power may be needed. Since the energy consumption of the light source is low, the integrated battery 350, as can be seen in Fi. 15, in the contact lens 300 can light up the contact lens 300 for a reasonably long period of time before the eye needs a new correcting power, and hence, replacing the contact lens 300 with a new refractive power and a new battery. This can be in the order of a couple of months. Taking into account the hygiene of the contact lens 300 and maintenance, the contact lens 300 can be replaced even sooner with the same refractive power and a new battery, if production costs allow.

### REFERENCE NUMERALS

100 Apparatus
110 Participant
120 Eyeball
130 Optic Nerve
135 Blind Spot
138 Optic Nerve Head
150 Keyboard
160 Eye tracking device
170 Display device
175 Light Source
176 Radiation
180 Stimulus
182 Blue light
200 Contact Lens
202 Anterior lens surface
204 Posterior lens surface
205 Central thickness
210 Surface of the contact lens
220 Aperture
230 Tube
235 Front entry
240 Optical Axis
250 Fresnel lens
300 Contact Lens
302 Human eye
303 Cornea
304 Pupil
310 Integrated light source
311 Beam diameter range
315 Micro lenses
320 Off-Axis
330 Central Axis
340 External Battery
341 Wires
350 Integrated Battery
360 Integrated coil

1. A contact lens (200) having an optical axis (240) and comprising an aperture (220) on the surface (210), wherein the aperture (220) is located off-center of the optical axis (240) and the aperture (220) has a central axis which is arranged such that collimated light exiting the aperture (220) is directed towards a blind spot (135) located at an optic nerve head (138).

2. The contact lens (200) of claim 1, further comprising a tube (230) connected to the opening of the aperture (220) and protruding from the surface (210).

3. The contact lens (200) of claim 1 wherein the contact lens (200) has a thickness of between 0.2 to 10 mm and a tube is formed as an aperture (220) through the contact lens (200).

4. The contact lens (200) of claim 2 or 3, wherein the tube (220, 230) is coated on its inner surface with a non-reflective coating, such that light in the wavelengths of between 420 nm and 500 nm is not reflected inside the tube (220, 230).

5. The contact lens (200) of any of the above claims, wherein the contact lens (200) is made of a material filtering out blue light.

6. The contact lens (200) of any of the above claims, wherein the contact lens (200) comprises a plurality of Fresnel lenses to focus the light to the optic nerve head (138) around the blind spot (135).

7. A system for applying radiation (176) from a light source (175) to a blind spot (135) at an optic nerve head (138) in an eye, wherein the system comprises the light source (175) for emitting the radiation (176) and a contact lens (200) having an optical axis (240) and comprising an aperture (220) on the surface (210), wherein the aperture (220) is located off-center of the optical axis (240) and the aperture (220) has a central axis which is arranged such that light entering the aperture (220) is directed towards the blind spot (135) for applying to the eye.

8. The system of claim 7, wherein the light source (175) is a light-emitting diode.

9. The system of claim 7 or claim 8, wherein the light source (170) is placed at a front entry (235) of one of the tube (230) or the aperture (220).

10. The system of one of claims 7 to 9, wherein the light source (170) emits polarized radiation.

11. A method for applying radiation (176) from a light source (170) to a blind spot (135) at an optic nerve head (138) of an eye comprising:
placing a contact lens having an optical axis (240) and comprising an aperture (220) on the surface (210), wherein the aperture (220) is located off-center of the optical axis (240) and the aperture (220) has a central axis which is arranged such that collimated light exiting the aperture (220) is directed towards the blind spot (135); and
shining the radiation (176) onto the eye.
